(19) United States
(12) Patent Application Publication
(10) Pub. No.: US 2026/0360628 A1
(43) Pub. Date: Nov. 12, 2026

(54) ELECTRODE FOIL, ENERGY STORAGE DEVICE, AND MANUFACTURING METHOD FOR SAME

(71) Applicant: NIPPON CHEMI-CON CORPORATION, Tokyo (JP)

(72) Inventors: Kazuhiro NAGAHARA, Tokyo (JP); kazuya KOSEKI, Tokyo (JP); Tsuyoshi KAWASHIMA, Saitama (JP)

(73) Assignee: NIPPON CHEMI-CON CORPORATION, Tokyo (JP)

(21) Appl. No.: 19/137,649

(22) PCT Filed: Dec. 8, 2023
(86) PCT No.: PCT/JP2023/044072

§ 371 Date: Jun. 11, 2025

(30) Foreign Application Priority Data
Dec. 15, 2022 (JP) 2022-200411

(51) Int. Cl. H01G 9/055; H01G 9/028; H01G 9/045; H01G 9/07; H01G 9/15

(52) U.S. Cl. CPC H01G 9/055; H01G 9/028; H01G 9/045; H01G 9/07; H01G 9/15

(57) ABSTRACT

A manufacturing method for an electrode foil, includes: performing a surface expansion treatment on a foil made from a valve metal; forming an oxide film layer on the foil subjected to the surface expansion treatment; cutting the foil on which the oxide film layer is formed; and forming, on a cut surface of the foil, a resin layer having a withstand voltage equal to or greater than a withstand voltage of the oxide film layer.

### TECHNICAL FIELD

The present disclosure relates to an electrode foil having an insulating film layer such as an oxide film layer, an energy storage device, and a manufacturing method for the same.

### BACKGROUND ART

In a solid electrolytic capacitor, which is an example of an energy storage device, it is already known to form an amorphous film as an oxide film on an electrode foil and to use this electrode foil to form a capacitor (see, for example, Patent Literature 1).

### PRIOR ART DOCUMENT

### Patent Literature

Patent Literature 1: WO2022/044932A

### SUMMARY OF INVENTION

### Problem to be Solved by the Invention

A withstand voltage of the solid electrolytic capacitor depends on the lowest withstand voltage determined by the oxide film formed on the electrode foil. Even when the withstand voltage of the oxide film formed on a surface of the electrode foil is increased, if there is a voltage range lower than this withstand voltage range, an effect of the increased withstand voltage of the oxide film formed on the surface of the electrode foil will not be reflected in a product withstand voltage of the solid electrolytic capacitor.

Typically, in a process of forming a capacitor element, a foil having an oxide film is cut to a predetermined shape. For this reason, a base metal of the foil is exposed on a cut surface produced by the cutting. Therefore, in a manufacturing process of the solid electrolytic capacitor, an element chemical conversion step is required in which a film is formed on the exposed base metal and a chemical conversion treatment is performed to prevent electrical contact between the base metal, which is a base foil exposed from the electrode foil, and a solid electrolyte.

Regarding the solid electrolytic capacitor having the oxide film on the electrode foil, FIG. 5 illustrates the withstand voltage of the solid electrolytic capacitor produced so that the solid electrolyte does not come into contact with the cut surface of the electrode foil. A horizontal axis is a film formation voltage of the electrode foil and a vertical axis is the withstand voltage of the solid electrolytic capacitor, and the withstand voltage relative to the film formation voltage is plotted (indicated by black circles).

According to this example, in the solid electrolytic capacitor in which the oxide film is formed so that the solid electrolyte does not come into contact with the cut surface of the electrode foil, the withstand voltage of the solid electrolytic capacitor increases depending on the film formation voltage of the electrode foil, even in a high voltage range of approximately 450 V or more, which is a limit value of the withstand voltage of the oxide film formed in the element chemical conversion step. On the other hand, in the solid electrolytic capacitor in which the oxide film is formed on the cut surface of the electrode foil in the element chemical conversion step, even when the withstand voltage of the oxide film exceeds 450 [V], the withstand voltage of the solid electrolytic capacitor remains at approximately 450 [V]. It indicates that the limit value of the withstand voltage of the oxide film formed in the element chemical conversion step becomes a limit of the withstand voltage of the solid electrolytic capacitor.

In other words, when comparing the withstand voltage of the oxide film on the surface of the electrode foil with the withstand voltage of the film formed on the cut surface of the electrode foil during the element chemical conversion step (hereinafter referred to as element chemical conversion film), a relation that the withstand voltage of the oxide film is greater than the withstand voltage of the element chemical conversion film is satisfied. From this relation, it can be understood that the withstand voltage of the solid electrolytic capacitor depends on the withstand voltage of the element chemical conversion film.

Inventors of the present disclosure have found that because the withstand voltage of the capacitor element and the final product depends on the withstand voltage of the foil, a treatment method for a base metal portion exposed on the cut surface of the foil during cutting can reduce the withstand voltage of the foil, and ultimately cause a reduction in the withstand voltage of not only the capacitor element but also the product.

Therefore, in view of the above problems and findings, an object of the present disclosure is to prevent a decrease in the withstand voltage of the foil due to a defective portion of the oxide film resulting from, for example, cutting.

The other object of the present disclosure is to repair the defective portion of the oxide film generated in the foil due to, for example, cutting after formation of an energy storage element, thereby improving the withstand voltage of the energy storage element or an energy storage device.

### Means for Solving the Problem

According to one aspect of a manufacturing method for an electrode foil of the present disclosure, the manufacturing method includes: a step of performing a surface expansion treatment on a foil made from a valve metal; a step of forming an oxide film layer on the foil subjected to the surface expansion treatment; a step of cutting the foil on which the oxide film layer is formed; and a step of forming, on a cut surface of the foil, a resin layer having a withstand voltage equal to or greater than a withstand voltage of the oxide film layer.

In the manufacturing method for an electrode foil, the step of forming the resin layer may include a forming step by electrophoretic electrodeposition.

In the manufacturing method for an electrode foil, a step of forming an oxide film by a repair chemical conversion treatment after formation of an electrophoretic electrodeposited film may be included.

According to one aspect of a manufacturing method for an energy storage device of the present disclosure, the manufacturing method includes the above-mentioned manufacturing method for an electrode foil; a step of forming an energy storage element using the electrode foil; and a step of forming a conductive polymer layer on the energy storage element.

In the manufacturing method for an energy storage device, a step of performing repair chemical conversion on the energy storage element to form an oxide film on the foil may be included.

According to one aspect of an electrode foil of the present disclosure, the electrode foil includes: a foil made from a valve metal; a surface-expanded layer formed on the foil; an oxide film layer formed on the surface-expanded layer; and a resin layer formed on at least a cut surface of the foil, in which the resin layer is formed to be thick in a base metal portion exposed on the cut surface and gradually become thinner toward a foil surface.

According to one aspect of an energy storage device of the present disclosure, the energy storage device includes: an energy storage element using the above-mentioned electrode foil, in which the energy storage element has a conductive polymer layer.

### Effects of Invention

According to the present disclosure, any one of the following effects can be obtained.

(1) According to the manufacturing method for an electrode foil of the present disclosure, at least the cut surface of the foil is repaired with an insulating film layer, thereby preventing a decrease in the withstand voltage of the foil that depends on the cut surface of the foil, and making it possible to manufacture an electrode foil with a high withstand voltage.

(2) According to the manufacturing method for an energy storage device of the present disclosure, the cut surface of the foil is repaired during a manufacturing stage of the electrode foil, thereby increasing the withstand voltage of the energy storage device. Even when an electrode foil having an oxide film layer with a defective portion is used, the defective portion on the oxide film layer is subjected to the repair treatment after the energy storage element is formed, thereby similarly increasing the withstand voltage of the energy storage device.

(3) According to the electrode foil of the present disclosure, an insulating film layer having a withstand voltage equal to or greater than that of the oxide film layer is formed on the cut surface of the foil that is generated in the foil during manufacturing, thereby increasing the withstand voltage of the entire electrode foil, so that a withstand voltage of an element using this electrode foil can be increased.

(4) According to the energy storage device of the present disclosure, the electrode foil in which the defective portion is repaired during manufacturing of the electrode foil is used, so that the withstand voltage can be increased.

### BRIEF DESCRIPTION OF DRAWINGS

FIG. 1A of FIG. 1 is a diagram illustrating a forming process of an energy storage element, and B of FIG. 1 is a perspective view illustrating the energy storage element.

FIG. 2 is a graph showing experimental results of Example 1, Example 2, Comparative Example 6, Comparative Example 7, Comparative Example 9, and Comparative Example 11.

FIG. 3A of FIG. 3 is a cross-sectional view illustrating a cut surface of a foil, and B of FIG. 3 is a cross-sectional view illustrating the cut surface of the foil after electrophoretic electrodeposition treatment.

FIG. 4 is a diagram for explaining a state of the foil that has been subjected to the electrophoretic electrodeposition treatment and before a repair chemical conversion treatment.

FIG. 5 is a graph showing a withstand voltage of a solid electrolytic capacitor relative to a film formation voltage of an electrode foil.

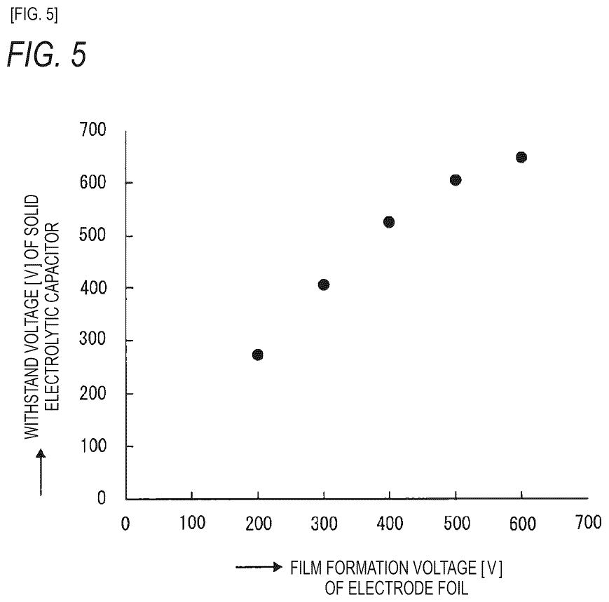

### EMBODIMENTS FOR CARRYING OUT THE INVENTION

### First Embodiment

A manufacturing process for an energy storage device according to a first embodiment is an example of an electrode foil and an energy storage device of the present disclosure, and a manufacturing method for the same.

The manufacturing process of the energy storage device includes formation of a valve metal foil (hereinafter simply referred to as “foil”), a surface expansion treatment, formation of an oxide film layer, cutting of the foil, repair of a cut surface of the cut foil, and formation of an energy storage element. In this manufacturing process, steps from the formation of the foil to the repair of the cut surface of the foil constitute an example of a manufacturing method for an electrode foil according to the present disclosure, and the foil produced in this manufacturing process is an example of an electrode foil according to the present disclosure.

In the formation of the foil, a valve metal is used as a raw material to form the foil. A shape of the foil may be, for example, a plate or a strip depending on a shape of the energy storage device or the energy storage element.

The foil is subjected to the surface expansion treatment to increase a surface area thereof. The surface expansion treatment is performed by, for example, chemical etching, to form a surface-expanded layer on the foil. The chemical etching is a treatment of immersing the foil in a chemical conversion solution, performing an etching treatment on a surface of the foil, forming unevenness on the surface of the foil to increase a capacitance thereof, and increasing the surface area of the foil. The uneven surface has, for example, a porous structure. The uneven surface is formed by DC etching using a direct current, AC etching using an alternating current, or by vapor deposition or sintering of metal particles onto the valve metal foil. In the DC etching or the AC etching, the valve metal foil is immersed in an acidic aqueous solution containing halogen ions such as hydrochloric acid, and the direct current or the alternating current is passed through the valve metal foil in this acidic aqueous solution to make the metal surface into an uneven surface and increase the surface area thereof.

Next, an oxide film layer is formed on the foil whose surface has been expanded by the surface expansion treatment to prepare a base foil. As the oxide film layer, an amorphous oxide film layer having a non-crystalline (amorphous) nature is formed by performing an amorphization treatment on the oxide film layer. This oxide film layer provides toughness and corrosion resistance.

The foil formed with the oxide film layer is cut, and subjected to a cutting treatment (that is, cut-out treatment) to cut out a foil having a predetermined shape. The foil formed with the oxide film layer is formed from any shape into a foil piece of a standard shape required for an element of the energy storage device.

When the foil after the oxide film layer is formed is subjected to the cutting treatment, a cut surface is formed on the foil of a predetermined shape obtained from the original foil. A base metal portion of the foil is exposed on this cut surface. This base metal portion is the valve metal that has not been subjected to the surface expansion treatment and is not covered by the oxide film layer. As described above, even if the oxide film layer is formed on the cut surface of the foil, the cut surface is still a portion with the lowest withstand voltage, and as a result, becomes a portion that causes a decrease in the withstand voltage of the foil.

After cutting the foil, the cut surface of the foil is repaired. For example, an electrophoretic electrodeposition treatment is performed to form an insulating film layer on the cut surface of the foil, so that an electrode foil is produced. At least the base metal portion is covered by this insulating film layer. This insulating film layer may be an insulating resin layer. It is preferable to form the insulating film layer having a withstand voltage equal to or greater than that of the oxide film layer. In other words, if the insulating film layer formed by repair or regeneration has a withstand voltage equal to or greater than that of the existing oxide film layer, dependency of the withstand voltage of the foil on the withstand voltage of the oxide film layer formed on the cut surface of the foil can be improved.

The foil with the cut surface of the foil repaired (that is, the foil with the insulating film layer formed on the cut surface of the foil) is used to form an element. The element is an energy storage element such as a solid electrolytic capacitor element. The energy storage element has, for example, a sandwich structure in which an anode electrode foil and a cathode electrode foil face each other with a separator therebetween. A capacitance of the energy storage device depends on a facing area.

This energy storage element is impregnated with an electrolyte to form an electrolytic capacitor element. As the electrolyte, a solid electrolyte is used. The solid electrolyte contains a conductive polymer. The conductive polymer is a conjugated polymer doped with an acid component as a dopant. The conjugated polymer is obtained by chemical oxidative polymerization or electrolytic oxidative polymerization of a monomer having a x-conjugated double bond or a derivative thereof. By performing a doping reaction on the conjugated polymer, the conductive polymer exhibits high conductivity. As the conjugated polymer, any known polymer can be used without any particular limitation. For example, examples of the conjugated polymer include polypyrrole, polythiophene, polyfuran, polyaniline, polyacetylene, polyphenylene, polyphenylenevinylene, polyacene, and polythiophenevinylene. These conjugated polymers may be used alone or in combination of two or more kinds, and the conjugated polymer may further be a copolymer of two or more kinds of monomers. Representative examples of the conductive polymer include poly(3,4-ethylenedioxythiophene) doped with polystyrene sulfonic acid (PSS), which is called PEDOT. As the acid dopant, any known acid dopant can be used without any particular limitation. Examples thereof include inorganic acids such as boric acid, nitric acid, and phosphoric acid, and organic acids such as acetic acid, oxalic acid, citric acid, ascotic acid, tartaric acid, squaric acid, rhodizoic acid, croconic acid, salicylic acid, p-toluenesulfonic acid, 1,2-dihydroxy-3,5-benzenedisulfonic acid, methanesulfonic acid, trifluoromethanesulfonic acid, borodisalicylic acid, bisoxalateborate acid, sulfonylimide acid, dodecylbenzenesulfonic acid, propylnaphthalenesulfonic acid, and butylnaphthalenesulfonic acid. A polyanion can also be used as the dopant, and examples of the polyanion include polyvinyl sulfonic acid, polystyrene sulfonic acid, polyallylsulfonic acid, polyacrylicsulfonic acid, polymethacrylic sulfonic acid, poly(2-acrylamido-2-methylpropanesulfonic acid), polyisoprene sulfonic acid, polyacrylic acid, polymethacrylic acid, and polymaleic acid. The dopants may be used alone or in combination of two or more kinds. Alternatively, polymers or monomers may be used. As the electrolyte, an electrolytic solution may be used in addition to the solid electrolyte.

### Effects of First Embodiment

According to the first embodiment, any one of the following effects can be obtained.

(1) After the oxide film layer is formed on the foil, the base metal portion of the foil with no oxide film layer formed thereon is exposed on the cut surface of the foil due to the cutting of the foil. The insulating film layer is formed on this base metal portion by the repair treatment after the cutting. In this way, the decrease in the withstand voltage caused by the cut surface of the foil can be improved. Therefore, an electrode foil with a high withstand voltage can be manufactured.

(2) Since the cut surface of the foil generated by cutting can be repaired, a degree of freedom in cutting the foil can be increased, which is advantageous since it allows the foil to be freely shaped according to the shape of the original foil or a device.

(3) The cut surface of the foil can be repaired by electrophoretic electrodeposition, a chemical conversion treatment, and the like, and the repair can be performed during the manufacturing process of the electrode foil.

(4) The cut surface of the foil can be repaired by a repair treatment, the decrease in the withstand voltage due to the base metal portion exposed on the cut surface of the foil is improved, and an electrode foil with a high withstand voltage can be manufactured.

(5) The decrease in the withstand voltage due to the base metal portion exposed on the cut surface of the foil is improved, the electrode foil with a high withstand voltage can be used to manufacture an energy storage device such as a fixed electrolytic capacitor, which can contribute to manufacture of an energy storage device with excellent electrical properties and no variation in the withstand voltage.

### Mechanism of Improving Withstand Voltage of Foil by Repairing Cut Surface of Foil

In the foil, as described above, after the surface expansion treatment, the oxide film layer is formed on the surface of the foil. This oxide film layer is damaged by the cutting, and the base metal portion of the foil, with no oxide film layer, is exposed on the cut surface of the foil. An insulating film layer can be formed on this base metal portion to repair the cut surface of the foil and repair the foil to the same withstand voltage as the original oxide film layer.

A material covering the base metal portion of the foil may be an insulator, and this insulating film layer may be an insulating resin layer, and for example, an insulating film layer having a withstand voltage equal to or greater than that of the oxide film layer is formed. The insulating film layer covering the base metal portion can achieve a withstand voltage equal to or greater than that of the existing oxide film layer. Therefore, the withstand voltage of the defective portion of the oxide film layer can be improved, and by repairing this defective portion, the withstand voltage of the entire foil can be increased.

### Second Embodiment

The manufacturing process of the energy storage device includes formation of a foil, a surface expansion treatment, formation of an oxide film layer, cutting of the foil, first repair for repairing a cut surface of the foil, second repair for repairing the oxide film layer, and formation of an element. In this manufacturing process, steps from the formation of the foil to the repair of the oxide film layer constitute an example of a manufacturing method for an electrode foil according to the present disclosure, and the foil produced in this manufacturing process is an example of an electrode foil according to the present disclosure.

The formation of the foil, the surface expansion treatment, the formation of the oxide film layer, and the cutting of the foil are the same as those in the first embodiment, so the description thereof will be omitted.

As in the first embodiment, a repair treatment or a regeneration treatment for the cut surface of the foil is performed on the foil after cutting as the first repair for repairing the cut surface of the foil. In the second embodiment, for example, an electrophoretic electrodeposition treatment is performed on the foil after cutting to form an insulating film layer on the cut surface of the foil. Therefore, the first repair for repairing the cut surface of the foil is common to the repair of the cut surface of the foil in the first embodiment.

After the treatment of the first repair for repairing the cut surface of the foil, the second repair for repairing the oxide film layer is performed as a complementary treatment to the first repair. In the second embodiment, a treatment of repairing the cut surface of the foil is performed in two stages, by the first repair for repairing the cut surface of the foil and the second repair that is different from the first repair. That is, the first repair is performed by, for example, the electrophoretic electrodeposition treatment, and the second repair for repairing the defective portion remaining in the oxide film layer is performed by, for example, a chemical conversion treatment.

The foil after the second repair is used to form an element. The formation of the element is similar to that in the first embodiment, and therefore the description thereof will be omitted.

### Effects of Second Embodiment

According to the second embodiment, any one of the following effects can be obtained.

(1) Since the first repair for repairing the cut surface of the foil is performed, which is common to the first embodiment, the cut surface of the foil is repaired by the first repair, and the same effects as in the first embodiment are obtained.

(2) In a case where a defective portion remains in the oxide film layer after the first repair by, for example, electrophoretic electrodeposition, if the defective portion is repaired by the second repair by, for example, a chemical conversion treatment after the first repair, the treatment of the first repair is complemented by the second repair, thereby improving repair accuracy of the defective portion.

### Mechanism of Withstand Voltage Improvement by Chemical Conversion Treatment after Electrophoretic Electrodeposition Treatment

For example, if the electrophoretic electrodeposition treatment is performed in the treatment of the first repair and a chemical conversion treatment is performed in the treatment of the second repair, a repair effect of the chemical conversion treatment is added to a repair effect of the electrophoretic electrodeposition. In other words, an effect obtained by re-repairing the oxide film layer is added, and the withstand voltage of the oxide film layer can be improved. Therefore, the repair accuracy of the defective portion in the oxide film layer is improved, thereby increasing the withstand voltage of the foil.

### Benefits of Re-Repairing Oxide Film Layer by Chemical Conversion Treatment after Electrophoretic Electrodeposition Treatment

a) The repair for the defective portion of the oxide film layer can be complemented by the chemical conversion treatment, and a treatment time of the first repair by the electrophoretic electrodeposition treatment can be shortened.

b) If a complementary treatment by chemical conversion is performed, the repair function can be shared by the electrophoretic electrodeposition treatment and the chemical conversion treatment, the treatment time of the electrophoretic electrodeposition can be shortened, and as a result, the time of the repair treatment can be shortened.

### Benefits of Preceding Treatment of Electrophoretic Electrodeposition Treatment

If performing the electrophoretic electrodeposition on an exposed portion of the base metal portion in the foil generated by cutting, the insulating film layer can be grown quickly to form an insulating film layer that covers the exposed portion. In other words, this preceding treatment increases the withstand voltage of the cut surface of the foil.

### Third Embodiment

The manufacturing process of the energy storage device includes formation of a foil, a surface expansion treatment, formation of an oxide film layer, cutting of the foil, formation of an element, and repair of the oxide film layer. In this manufacturing process, steps from the formation of the foil to the cutting of the foil and a step of adding the repair for the cut surface of the foil, and the produced foil constitute an example of an electrode foil and a manufacturing process therefor of the present disclosure.

The formation of the foil, the surface expansion treatment, the formation of the oxide film layer, the cutting of the foil, and the formation of the element are the same as those in the first embodiment, and therefore the description thereof will be omitted.

In the first embodiment and the second embodiment, the cut surface of the foil is repaired before the formation of the element, whereas in the third embodiment, the cut surface of the foil is repaired by an electrophoretic electrodeposition treatment after the formation of the element.

### Effects of Third Embodiment

According to the third embodiment, any one of the following effects can be obtained.

(1) By preceding the formation of the element, the defective portion present on the cut surface of the foil can be repaired after the formation of the element.

(2) Since the repair treatment is performed on the energy storage element, which is an intermediate product, it is possible to quickly shift from foil manufacturing to element formation, and after the repair treatment is performed at the element stage, the effect of improving the withstand voltage can be confirmed after the element is formed.

### EXAMPLES

The Examples include Examples 1 to 3 and Comparative Examples 1 to 11 for comparison. In the present disclosure, the term “Comparative” refers to comparison with Examples 1 to 3. The term “Comparative” does not indicate whether belonging to the invention according to the claims or not.

### Example 1

The manufacturing process of Example 1 includes formation of an amorphous oxide film layer, cutting out of a foil, an electrophoretic electrodeposition treatment, and formation of an element.

The formation of the amorphous oxide film layer is performed after the formation of the foil made from a base material (the above-mentioned valve metal) and the surface expansion treatment of the foil. This amorphous oxide film layer is an example of the oxide film layer of the present disclosure, and is produced by subjecting the oxide film layer formed on the foil to an amorphization treatment.

The foil is formed from the valve metal. After the surface of the foil is subjected to a surface expansion treatment by etching, the amorphous oxide film layer is formed on the foil. This amorphous oxide film layer is an example of the oxide film layer of the present disclosure. A step of forming the amorphous oxide film layer includes a step of forming a porous film layer and a chemical conversion step.

For example, the foil is immersed in an aqueous oxalic acid solution maintained at a certain temperature of 25 [°C], and anodization is performed by applying a constant current. A porous film layer is formed on the surface of the foil by the anodization.

The foil on which the porous film layer is formed is immersed in an aqueous boric acid solution maintained at a certain temperature of, for example, 85 [°C], and a current is applied to the aqueous boric acid solution at a certain current density of 25 [mA/cm²] to perform chemical conversion. In this chemical conversion, a chemical conversion voltage reaches a predetermined value (for example, 700 [V]) and then is continued (=held) for a certain period of time, for example, 10 minutes. In this way, an amorphous oxide film layer (hereinafter simply referred to as “oxide film layer” or “amorphous oxide film layer”) can be formed inside the porous film layer of the foil. This oxide film layer is an example of the oxide film layer of the present disclosure.

Cutting out of the foil on which the amorphous oxide film layer is formed is an example of the cutting of the foil of the present disclosure. In this step, a foil having a shape required for the energy storage element is cut out from the base foil. The foil having a predetermined shape is formed by cutting out from the base foil, but the base metal (base material, valve metal) is exposed from the cut surface of the foil. In other words, no oxide film layer exists on the base metal portion exposed on this cut surface.

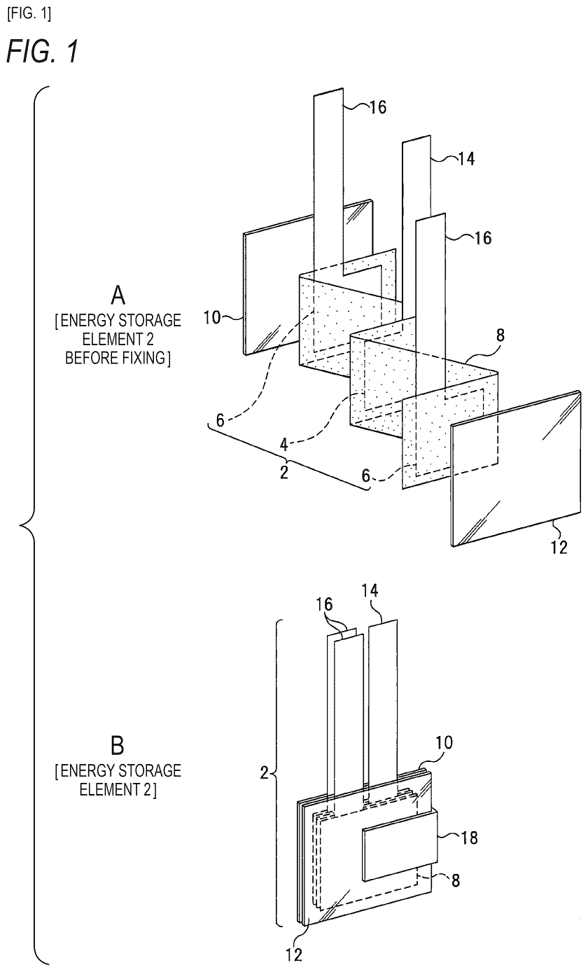

In Example 1, for example, a laser processing machine is used as a cutting means for cutting out a foil piece from the foil on which the amorphous oxide film layer is formed. As described above, the base metal portion (valve metal) of the base material is exposed by the cutting out on the cut surface of the foil piece cut out from the foil by laser processing. For example, as illustrated in FIG. 1, the foil piece includes a square anode portion and a lead portion (anode lead portion 14) protruding from one edge of the anode portion. The anode portion is an example of a functional portion that functions as an anode of the energy storage element. The one edge of the anode portion has a length of 1.0 [cm]. A width of the lead portion is smaller than the one edge of the anode portion. In Example 1, the width of the lead portion is 0.5 [cm].

Next, the foil cut into the shape required for the energy storage element is subjected to the electrophoretic electrodeposition treatment. The electrophoretic electrodeposition treatment is one example of the repair for the cut surface of the foil in the first embodiment. By the electrophoretic electrodeposition treatment, a resin as an insulator, which is an insulating film layer, is formed on the cut surface of the foil by electrophoretic electrodeposition, and the cut surface of the foil is repaired with the resin. The electrophoretic electrodeposition is performed using an electrophoretic electrodeposition apparatus. This electrophoretic electrodeposition apparatus includes a treatment vessel made from a conductive metal such as stainless steel (SUS). The treatment vessel is filled with a resin dispersion. For this resin dispersion, a treatment liquid in which a resin is dispersed in a solvent is used. The resin dispersion is set so that the entire square anode portion and most of the lead portion are immersed in the treatment vessel.

A DC power source and a voltmeter are connected to the foil piece and the treatment vessel via a switch, with the foil piece as an anode and the treatment vessel as a cathode. The DC power source applies a certain DC voltage of, for example, 100 [V], to the foil piece set as an anode and to the treatment vessel set as a cathode and filled with the resin dispersion, and constitutes a driving source of the electrophoresis treatment on the foil piece. The treatment time of the electrophoretic electrodeposition is regulated by a timer provided in the electrophoretic electrodeposition apparatus. In Example 1, the electrophoretic electrodeposition treatment is performed for a certain period of time of 120 [seconds] to electrodeposit the resin onto the cut surface of the foil of the foil piece. The foil piece that has been subjected to the electrophoretic electrodeposition step is taken out from the resin dispersion and washed to remove the resin dispersion. After the washing, the foil piece is dried. This drying is performed by leaving the foil piece at a certain temperature of, for example, 60 [°C], for a certain period of time of, for example, 10 [minutes]. After the drying, the foil piece is heated to perform a crosslink treatment on the electrophoretic electrodeposited film. This heating is performed at a certain temperature of, for example, 180 [°C], for a certain period of time of, for example, 40 [minutes].

The formation of the element is performed using the foil that has been subjected to the electrophoretic electrodeposition treatment. The formation of the element is similar to the formation of the element in the first embodiment. Specifically, the element was formed by the following process.

A of FIG. 1 illustrates an example of a formation process of an energy storage element 2. This forming process is an example of the electrode foil, the energy storage device, and the manufacturing method for the same according to the present disclosure.

As an example, the energy storage element 2 includes one anode foil 4, two cathode foils 6, and a separator 8, and is attached with two support plates 10, 12. The anode foil 4 is a foil piece that has been subjected to the above-mentioned treatment. The anode foil 4 is formed with an anode lead portion 14 on a square anode portion.

The cathode foil 6 uses a foil that has the same shape as the anode foil 4. The cathode foil 6 is formed with a cathode portion facing the anode portion, and is formed with a cathode lead portion 16. The cathode portion is a functional portion that functions as a cathode of the energy storage element 2.

The separator 8 is, for example, a sheet formed of a regenerated cellulose material, and is zigzag-folded into units of, for example, square separator portions, which are larger than the anode portion of the anode foil 4. The separator 8 is formed, for example, into a belt-shaped sheet using a regenerated cellulose material and having a width sufficient to cover the anode portion of the anode foil 4. Therefore, the energy storage element 2 is formed by placing two cathode foils 6 on front and back surfaces of one anode foil 4 so as to sandwich the zigzag-folded separator 8 therebetween.

After the formation of the energy storage element 2, a conductive polymer layer is formed on the anode foil 4 and the cathode foils 6. The formation step of the conductive polymer layer includes impregnation with a resin dispersion and drying of the energy storage element 2. This resin dispersion is prepared by dispersing PEDOT fine particles and polystyrene sulfonic acid in an aqueous solution containing 5% ethylene glycol. The PEDOT fine particles are an example of the conductive polymer of the present disclosure. As impregnation conditions, for example, a reduced pressure of 50 [kPa] and a certain impregnation time of, for example, 5 [minutes] are set, and the energy storage element 2 is impregnated with the dispersion. After being impregnated with the dispersion, the energy storage element 2 is dried. As drying conditions, for example, the energy storage element 2 is placed at a certain temperature of 110 [°C], and the energy storage element 2 is dried for a certain drying time of, for example, 30 [minutes].

B of FIG. 1 illustrates the energy storage element 2 disposed on the support plates 10, 12. The support plates 10, 12 may be made from a tough insulating material, such as a glass slide. In this energy storage element 2, two cathode foils 6 are arranged on one anode foil 4 with the separator 8 sandwiched therebetween, and are held between the support plates 10, 12. The support plates 10, 12 are an example of a support member that holds the energy storage element 2, and the support plates 10, 12 are firmly held by a clip 18, for example.

### Example 2

Example 2 differs from Example 1 in that a repair chemical conversion treatment is performed after the electrophoretic electrodeposition treatment. In other words, except for performing the repair chemical conversion treatment after the electrophoretic electrodeposition treatment, the manufacturing process of the anode foil and the formation process of the element in Example 2 are the same as those in Example 1, and the conditions for the electrophoretic electrodeposition treatment in Example 2 are the same as those in Example 1, and therefore, the description thereof is omitted. The electrophoretic electrodeposition treatment corresponds to the first repair for repairing the cut surface of the foil in the second embodiment, and the repair chemical conversion treatment corresponds to the second repair for the oxide film layer in the second embodiment. In other words, the defective portion in the oxide film layer is repaired by a two-stage treatment including the electrophoretic electrodeposition treatment and the repair chemical conversion treatment.

### Repair (Repair Chemical Conversion) of Amorphous Oxide Film Layer

This amorphous oxide film layer is repaired by the repair chemical conversion treatment. The repair chemical conversion treatment is a treatment of passing an electrical current through the foil in an aqueous boric acid solution. In this treatment, the foil is immersed in the aqueous boric acid solution at a certain temperature of, for example, 85 [°C], and a current density of 0.4 [mA/cm²] is applied to the foil, and after a predetermined voltage of, for example, 630 [V] has been reached, this voltage of 630 [V] is held for a certain period of time of, for example, 10 [minutes]. Then, the defective portion of the oxide film layer was repaired. In this way, since the repair of the amorphous oxide film layer is performed by a two-stage treatment, that is, the electrophoretic electrodeposition treatment and then the repair chemical conversion treatment, the repair accuracy of the defective portion generated in the amorphous oxide film layer can be improved.

### Example 3

Example 3 corresponds to the third embodiment, and as described above, after the formation of the energy storage element 2, the electrophoretic electrodeposition treatment is performed to form a conductive polymer layer on the anode foil 4 of the energy storage element 2. Therefore, it is possible to repair the defective portion generated in the oxide film layer of the anode foil 4 of the energy storage element 2 even during the formation stage of the energy storage element 2.

### Comparative Example 1

Comparative Example 1 differs from Example 2 in that the repair chemical conversion treatment is performed before the electrophoretic electrodeposition treatment. In other words, Comparative Example 1 was produced such that the steps up to cutting out the foil piece and the steps after forming the element were the same as those in Example 2, except for performing the electrophoretic electrodeposition treatment after the repair chemical conversion treatment, and the conditions for the electrophoretic electrodeposition treatment and the repair chemical conversion treatment were also the same as those in Example 2, and therefore the description thereof is omitted.

### Comparative Example 2

Comparative Example 2 differs from Example 2 in that the cutting out the foil is carried out before the formation of the amorphous oxide film layer. In other words, Comparative Example 2 was produced such that the steps after cutting out the foil and then forming an amorphous oxide film layer on the foil piece were the same as in Example 2, and the conditions for each step were the same as those in Example 2, and therefore the description thereof is omitted.

The formation of this amorphous oxide film layer is the same treatment as the formation of the amorphous oxide film layer in Example 1, but it is believed that the amorphous oxide film layer is formed uniformly over the entire foil, including the cut surface of the cut-out foil, not just on the surface of the foil. Since the amorphous oxide film layer is formed after the foil is cut, there is a risk that the amorphous oxide film layer will be incompletely formed on the cut surface produced by cutting out the foil. It also causes a defective portion in the oxide film layer and causes a decrease in the withstand voltage of the foil.

### Comparative Example 3

Comparative Example 3 differs from Comparative Example 1 in that the cutting out the foil is carried out before the formation of the amorphous oxide film layer. In other words, Comparative Example 3 was produced such that the steps after forming the amorphous oxide film layer on the foil piece cut out from the foil, specifically, the steps after the step of the repair chemical conversion treatment, were the same as those in Comparative Example 1, and the conditions for each step were the same as those in Comparative Example 1, and therefore, the description thereof is omitted.

### Comparative Example 4

In Comparative Example 4, the order of the steps and the conditions for each step were the same as those in Comparative Example 3, except that the repair chemical conversion treatment in Comparative Example 3 was omitted, and therefore, the description thereof is omitted.

### Comparative Example 5

In Comparative Example 5, instead of the electrophoretic electrodeposition treatment in Example 2, an end face resist treatment was performed. When performing the end face resist treatment, a length of one side was set to 1.2 [cm] in order to ensure a printing width (0.1 [cm]) of a resist resin covering the cut surface of the foil piece. Except for the size of the foil piece and the use of the end face resist treatment instead of the electrophoretic electrodeposition treatment, the order of the steps and the conditions for each step were the same as those in Example 2, and therefore the description thereof is omitted.

### End Face Resist Treatment

This end face resist treatment is a treatment of covering a base metal portion exposed on the cut out foil, for example, the cut surface of the foil piece, with a solder resist resin to insulate an exposed portion of the base metal. This end face resist treatment includes a printing step, a first drying step, and a second drying step.

The printing step is a step of printing the solder resist resin on the cut surface of the foil. For this printing, for example, a screen printer is used, a certain width of, for example, 0.1 [cm], of the foil piece is set as a printing portion, and the solder resist resin is printed on this printing portion. That is, the solder resist resin covers the cut surface and also extends onto the foil surface adjacent to the cut surface, thereby increasing covering strength of a solder resist resin layer.

The first drying step is a treatment of drying one side of the solder resist resin layer formed on the foil. In this treatment, the solder resist resin layer together with the foil is heated at a certain heating temperature of, for example, 150 [°C], for a certain drying time of, for example, 10 [minutes], to dry the solder resist resin. Next, the second drying step is performed. The second drying step is a treatment of drying the other side of the solder resist resin layer. In this treatment, the other side of the solder resist resin layer, together with the foil, is similarly heated at a certain heating temperature of, for example, 150 [°C], for a certain drying time of, for example, 30 [minutes], which is longer than that for the one side, to dry the solder resist resin. In this way, the solder resist resin layer is fixed onto a foil end face as an end face resist layer.

### Comparative Example 6

In Comparative Example 6, instead of the electrophoretic electrodeposition treatment in Comparative Example 1, an end face resist treatment was performed. When performing the end face resist treatment, a length of one side was set to 1.2 [cm] in order to ensure a printing width (0.1 [cm]) of a resist resin covering the cut surface of the foil piece. Except for the size of the foil piece and the use of the end face resist treatment instead of the electrophoretic electrodeposition treatment, the order of the steps and the conditions for each step were the same as those in Comparative Example 1, and therefore the description thereof is omitted.

### Comparative Example 7

In Comparative Example 7, the order of the steps and the conditions for each step were the same as those in Comparative Example 5, except that the repair chemical conversion treatment in Comparative Example 5 was omitted, and therefore, the description thereof is omitted.

### Comparative Example 8

In Comparative Example 8, instead of the electrophoretic electrodeposition treatment in Comparative Example 2, an end face resist treatment was performed. When performing the end face resist treatment, a length of one side was set to 1.2 [cm] in order to ensure a printing width (0.1 [cm]) of a resist resin covering the cut surface of the foil piece. Except for the size of the foil piece and the use of the end face resist treatment instead of the electrophoretic electrodeposition treatment, the order of the steps and the conditions for each step were the same as those in Comparative Example 2, and therefore the description thereof is omitted.

### Comparative Example 9

In Comparative Example 9, the order of the steps and the conditions for each step were the same as those in Comparative Example 1, except that the electrophoretic electrodeposition treatment in Comparative Example 1 was omitted, and therefore, the description thereof is omitted.

### Comparative Example 10

In Comparative Example 10, the order of the steps and the conditions for each step were the same as those in Comparative Example 1, except that the repair chemical conversion treatment and the electrophoretic electrodeposition treatment in Comparative Example 1 were omitted, and therefore, the description thereof is omitted.

In Comparative Example 10, after the amorphous oxide film layer was formed, the foil was cut out and an element was formed. In this Comparative Example 10, the cut surface of the foil resulting from cutting out the foil is in an unrepaired state.

### Comparative Example 11

In Comparative Example 11, the order of the steps and the conditions for each step were the same as those in Comparative Example 2, except that the electrophoretic electrodeposition treatment and the repair chemical conversion treatment in Comparative Example 2 were omitted, and therefore, the description thereof is omitted.

In Comparative Example 11, after cutting out the foil, an amorphous oxide film layer is formed, and then an element is formed. In this Comparative Example 11, an amorphous oxide film layer is formed on the cut surface generated by cutting out the foil by the formation of the amorphous oxide film layer.

### Production Results of Energy Storage Element 2 According to Examples 1 and 2 and Comparative Examples 1 to 11

In Example 1, after cutting out the foil on which the amorphous film was formed, an insulating film layer was formed on the cut surface of the foil by electrophoretic electrodeposition, thereby producing the energy storage element 2.

In Example 2, after cutting out the foil on which the amorphous film was formed, an insulating film layer was formed on the cut surface of the foil by electrophoretic electrodeposition, and then the repair chemical conversion treatment was performed to produce the energy storage element 2.

In Comparative Example 1, the repair chemical conversion was performed on the cut surface of the foil piece on which the amorphous film was formed, and electrophoretic electrodeposition was attempted on the film after the repair chemical conversion, but an electrophoretic electrodeposited film could not be formed.

In Comparative Example 2, the amorphous film was formed on the foil piece cut out from the foil on which no amorphous film was formed, and then the electrophoretic electrodeposition treatment was performed, followed by the repair chemical conversion. In Comparative Example 2, an electrophoretic electrodeposited film could not be formed.

In Comparative Example 3, the amorphous film was formed on the foil piece cut out from the foil on which no amorphous film was formed, and then the repair chemical conversion was performed, and after the chemical conversion treatment, the electrophoretic electrodeposition treatment was performed. In Comparative Example 3, an electrophoretic electrodeposited film could not be formed either.

In Comparative Example 4, the amorphous film was formed on the foil piece cut out from the foil on which no amorphous film was formed, and then the electrophoretic electrodeposition treatment was attempted. In Comparative Example 4, an electrophoretic electrodeposited film could not be formed either.

In Comparative Example 5, the foil piece was cut out from the foil on which the amorphous film was formed, and the cut surface was subjected to the end face resist treatment and then to the repair chemical conversion treatment. Comparative Example 5 was not suitable for the energy storage element 2 since the anode portion was deformed and the like.

In Comparative Example 6, the cut surface of the foil piece was subjected to the repair chemical conversion, and then covered with the end face resist, and then the energy storage element 2 was formed. In Comparative Example 6, since the end face resist was laminated on the oxide film layer obtained by the repair chemical conversion, Comparative Example 6 was able to function as a capacitor.

In Comparative Example 7, the cut surface of the foil piece was covered with the end face resist, and then the energy storage element 2 was formed. The cut surface of the foil piece is insulated by the end face resist. Comparative Example 7 was able to function as a capacitor.

In Comparative Example 8, the foil piece was cut out from the foil on which no amorphous film was formed, and after the amorphous film was formed, the cut surface was subjected to the end face resist treatment and then to the repair chemical conversion treatment. Comparative Example 8 was not suitable for the energy storage element 2 since the anode portion was deformed and the like.

In Comparative Example 9, the cut surface of the foil piece was subjected to the repair chemical conversion treatment, and then the energy storage element 2 was formed. Comparative Example 9 was able to function as a capacitor.

In Comparative Example 10, the foil piece was cut out from the foil after the amorphous film was formed, and then the energy storage element 2 was formed. The base metal portion is exposed on the cut surface of the foil piece. In Comparative Example 10, the base metal portion is short-circuited with the cathode, and therefore Comparative Example 10 does not function as a capacitor.

In Comparative Example 11, the foil piece was cut out from the foil on which no amorphous film was formed, and an amorphous film was formed on the foil piece, and then the energy storage element 2 was formed. Comparative Example 11 was able to function as a capacitor.

### Experimental Results of Energy Storage Element 2 According to Examples 1 and 2 and Comparative Examples 1 to 11

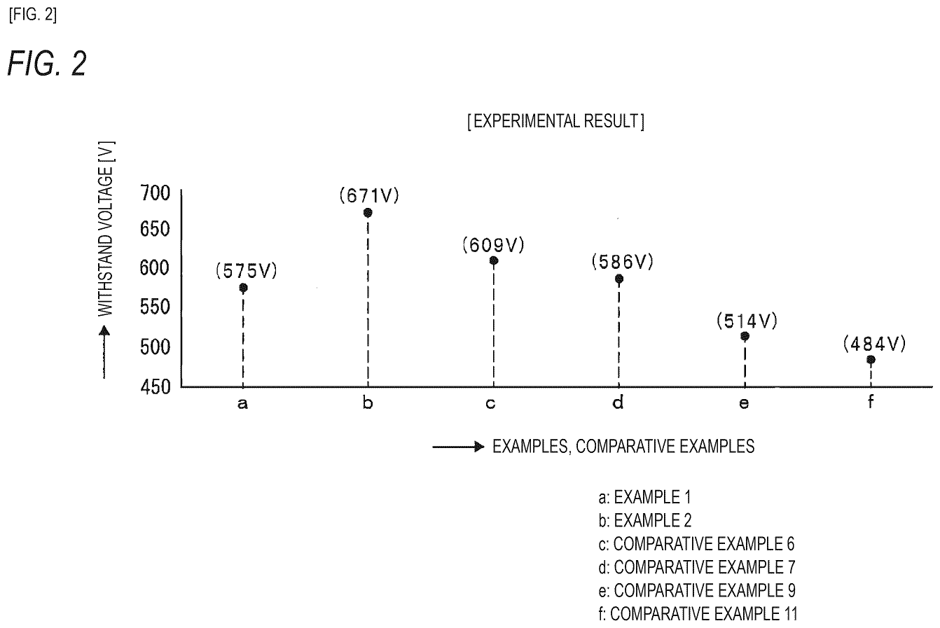

FIG. 2 shows measurement results of the withstand voltage of the energy storage elements 2 according to Examples 1 and 2 and Comparative Examples 6, 7, 9, and 11.

In Examples 1 and 2 and Comparative Examples 6, 7, 9, and 11, the withstand voltage could be measured, but in other Comparative Examples 1 to 5, 8, and 10, the withstand voltage could not be measured.

In Example 1, a withstand voltage of 575 [V], in Example 2, a withstand voltage of 671 [V], in Comparative Example 6, a withstand voltage of 609 [V], in Comparative Example 7, a withstand voltage of 586 [V], in Comparative Example 9, a withstand voltage of 514 [V], and in Comparative Example 11, a withstand voltage of 484 [V] was obtained.

If comparing the withstand voltage of Example 1 with the withstand voltage of Example 2, the withstand voltage of Example 2 is higher than the withstand voltage of Example 1. This is because in Example 1, after cutting out the foil, only electrophoretic electrodeposition is performed, whereas in Example 2, after the electrophoretic electrodeposition of Example 1, the repair chemical conversion treatment is performed. For this reason, it can be presumed that the defective portion was further repaired by the repair chemical conversion treatment, and the withstand voltage was improved.

If comparing the withstand voltage of Example 1 with the withstand voltage of Comparative Example 9, the withstand voltage of Example 1 is higher than the withstand voltage of Comparative Example 9. In Example 1, electrophoretic electrodeposition is performed after the foil is cut out, whereas in Comparative Example 9, the repair chemical conversion treatment is performed after the foil is cut out, and the difference therebetween is whether the repair treatment is the electrophoretic electrodeposition or the repair chemical conversion treatment. Therefore, it can be assumed that electrophoretic electrodeposition is a factor that increases the withstand voltage of the energy storage element 2. That is, in Comparative Example 9, only the repair chemical conversion was performed, and therefore the withstand voltage was low.

### Repair for Cut Surface of Foil by Electrophoretic Electrodeposition and Withstand Voltage of Energy Storage Element 2

Before the foil piece is cut out, an oxide film layer is formed on the foil after the surface expansion treatment.

As described above, the foil is cut by laser irradiation after the oxide film layer is formed.

On the cut surface generated by cutting out the foil, a laminated state of the oxide film layer, the etching layer and the base metal portion is exposed from an outer surface side of the foil. In this cut surface, the etching layer is a surface-expanded portion formed on the valve metal foil, and has electrical conductivity equivalent to that of the base metal portion. Here, the base metal portion refers to a metal portion not covered with etching. The oxide film layer is an amorphous oxide film layer formed on a surface of the etching layer, and the etching layer is a roughened layer formed on the base metal portion by the surface expansion treatment. The base metal portion is a valve metal portion that serves as a base material.

As described above, the cut surface is repaired by a film formation method using electrophoretic electrodeposition. As described above, in this electrophoretic electrodeposition, the foil is immersed in a resin dispersion, and a potential difference is applied to cause the resin in the resin dispersion to precipitate (electrodeposit) on the base metal portion 22, thereby forming a resin layer.

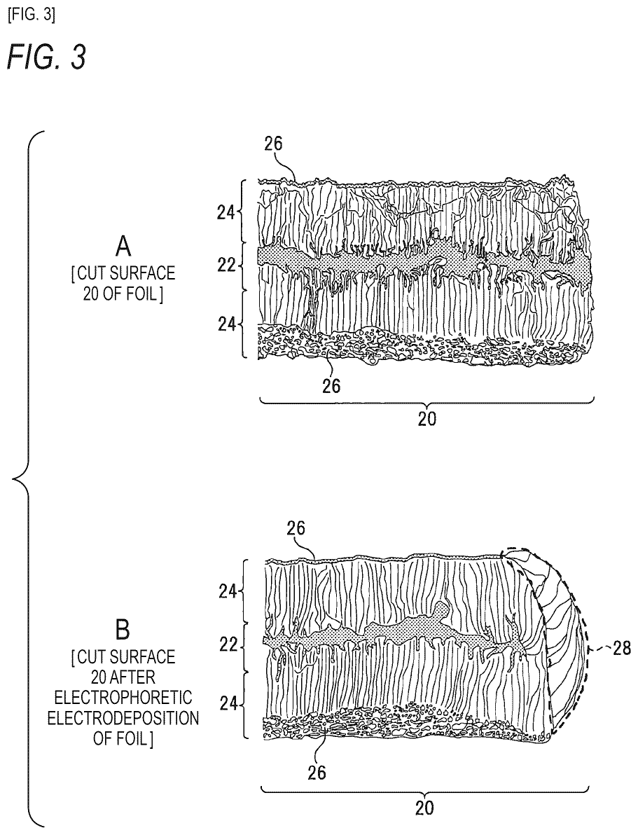

A of FIG. 3 illustrates an enlarged cut surface 20 of the foil before the electrophoretic electrodeposition. This enlarged diagram is a sketch of an electron microscope photograph. On this cut surface 20, etching layers 24 are formed on front and back surface sides of a base metal portion 22, and an oxide film layer 26 is formed on an outer surface side of each etching layer 24.

B of FIG. 3 illustrates an enlarged cut surface 20 of the foil before the electrophoretic electrodeposition. This enlarged diagram is also a sketch of an electron microscope photograph. An electrophoretic electrodeposited film 28 is formed on an exposed surface of the base metal portion 22 by electrophoretic electrodeposition. The electrophoretic electrodeposited film 28 is a resin layer or an insulating layer that covers the base metal portion 22 and the etching layers 24 by electrophoretic electrodeposition.

This electrophoretic electrodeposited film 28 is an insulating film layer of the present disclosure, and is an insulating film layer that is formed to be thick on the base metal portion 22 and gradually become thinner toward the foil surface side.

The repair (film formation) treatment for the cut surface of the foil using the electrophoretic electrodeposited film 28 includes resin precipitation, electrolysis, resin adhesion, and improvement of the withstand voltage of the foil piece.

When an anode of a DC power source is connected to the foil piece immersed in the resin dispersion and a cathode thereof is connected to a treatment vessel filled with the resin dispersion, and a certain voltage is applied, electrophoresis occurs in the resin of the resin dispersion. This resin precipitates in the resin dispersion due to a decrease in pH.

For example, in a case where a base material of the valve metal is aluminum (Al), when the aluminum is anodized, electrolysis occurs in water of the resin dispersion, and a hydrogen ion exponent (pH) decreases at a portion where the electrolysis occurs. In other words, reactions expressed by the following chemical reaction formulas (1) and (2) occur.

Electrolysis of water: 2H₂O→4H⁺+O₂↑+4e⁻ (1)

Anodization of Al: Al³⁺+3H₂O→Al₂O₃+6H⁺+6e⁻ (2)

Current concentration occurs at the base metal portion 22 of the foil piece, causing the resin precipitated in the resin dispersion to adhere to the base metal portion 22.

The resin adheres to a portion where the oxide film layer 26 is not formed. That is, the resin adheres to the base metal portion 22 exposed on the cut surface 20, and the electrophoretic electrodeposited film 28 is formed by film formation using the resin, thereby repairing the cut surface of the foil. In this way, the withstand voltage of the foil piece is improved by the resin film.

### Combined Use of Electrophoretic Electrodeposition Treatment and Repair Chemical Conversion Treatment

In Example 2, the foil piece used in the energy storage element 2 is subjected to the electrophoretic electrodeposition treatment and then to the repair chemical conversion treatment, and the cut surface of the foil is repaired by the two-stage treatment including the electrophoretic electrodeposition treatment and the repair chemical conversion treatment.

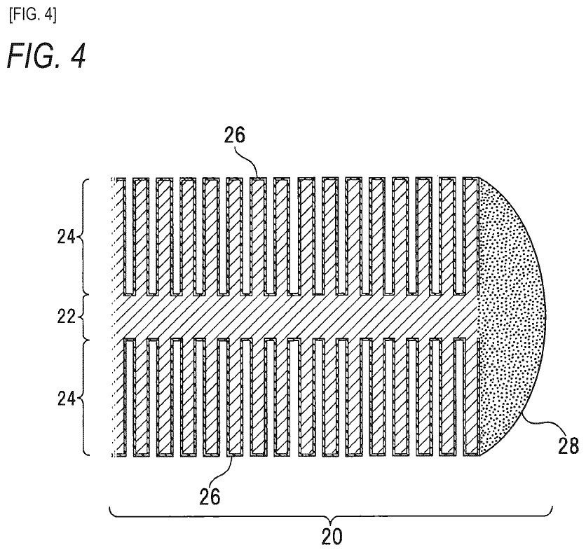

FIG. 4 illustrates an enlarged cross section of the foil piece after the electrophoretic electrodeposition treatment and before the repair chemical conversion treatment. In FIG. 4, the same portions as those in FIG. 3 are denoted by the same reference numerals.

In the cross section of the foil piece, the etching layers 24 are formed sandwiching the base metal portion 22, and the oxide film layer 26 is formed on the outer surface of the etching layer 24. The uneven shape of the etching layer 24 is a schematically indicated by countless etching pits. The electrophoretic electrodeposited film 28 is formed on the base metal portion 22 of this foil piece by the electrophoretic electrodeposition treatment. In other words, since the exposed portion of the base metal portion 22 of the foil piece causes a decrease in the withstand voltage of the foil piece, the electrophoretic electrodeposited film 28 is formed and insulation is provided by the above-mentioned resin, thereby eliminating the cause of the decrease in the withstand voltage of the foil piece.

The oxide film layer 26 is formed on the surface of the etching layer 24, but a plurality of defective portions are generated on the oxide film layer 26. The defective portion does not only refer to a state where the oxide film layer 26 is absent and the valve metal aluminum is exposed, but also to a state where the oxide film layer 26 is thinner than in other portions. This defective portion represents a microdefect, and since a portion through which the current flows in the resin dispersion is small in this microdefect, the resin cannot be adhered to the microdefect by the electrophoretic electrodeposition. If such a microscopic defective portion remains, a decrease in the withstand voltage of the oxide film layer 26 will be caused, and a decrease in the withstand voltage of the foil piece and even a decrease in the withstand voltage of the energy storage element 2 will be caused.

When the foil piece is subjected to the repair chemical conversion treatment after the electrophoretic electrodeposition treatment, the chemical conversion solution penetrates the defective portion, so as to form a repair chemical conversion film by the chemical conversion solution, and the defective portion is repaired by this repair chemical conversion film.

In the electrophoretic electrodeposited film 28, voids (air bubbles) may be generated in the electrophoretic electrodeposited film 28 due to oxygen gas generated during the formation of the electrophoretic electrodeposited film 28. These remaining voids are undesirable in terms of maintaining the withstand voltage.

When the foil piece after the electrophoretic electrodeposition is immersed in the repair chemical conversion solution, the repair chemical conversion solution penetrates into the electrophoretic electrodeposited film 28, passes through the voids and reaches the base metal portion 22 of the foil piece, and a repair chemical conversion film is formed on the base metal portion 22 facing the voids. Therefore, the withstand voltage of the foil piece after the electrophoretic electrodeposition can be further improved.

In this way, after the withstand voltage of the defective portion of the oxide film layer 26 is improved by the electrophoretic electrodeposition treatment with the electrophoretic electrodeposited film 28, the defective portion that could not be completely repaired by the electrophoretic electrodeposition treatment can be repaired with the repair chemical conversion film. In other words, the two-stage repair treatment can eliminate the cause of the decrease in the withstand voltage and improve the withstand voltage of the energy storage element 2.

### Repair for Oxide Film Layer by Repair Chemical Conversion Only (Comparative Example 9) and Withstand Voltage Thereof

In Comparative Example 9, the foil piece is cut out from the foil on which the amorphous oxide film layer is formed, and the cut surface is subjected to the repair chemical conversion treatment, and then the energy storage element 2 is produced. The withstand voltage of the energy storage element 2 is lower than the withstand voltage of Example 1. The reason why the withstand voltage in Comparative Example 9 is low is that the oxide film layer generated by the repair chemical conversion is difficult to form on the base metal portion 22 exposed on the cut surface.

The withstand voltage of the oxide film layer on the base metal portion 22 formed by the repair chemical conversion is lower than the withstand voltage of the oxide film layer formed by the repair chemical conversion on the defective portion of the oxide film (an assumed withstand voltage of the oxide film formed by the repair chemical conversion). Since the withstand voltage of the energy storage element 2 depends on the withstand voltage of the oxide film on each end face, even when the oxide film layer is repaired by the repair chemical conversion, the withstand voltage cannot be increased by repairing the oxide film layer.

### Reason Why Oxide Film Layer is Difficult to Form on Base Metal Portion 22 by Repair Chemical Conversion

a) It is not possible to adhere a pretreatment layer to the cut surface of the foil piece, which serves as a base for forming a high-quality film with few defects, as in a normal chemical conversion pretreatment. For this reason, an oxide film with few defects is difficult to form.

b) The cut surface of the foil piece has scratches generated during cutting, and oxides are attached to the surface thereof, and factors such as impurities and burrs make it difficult to form a high-quality oxide film layer without defects. If impurities are present on the cut surface of the foil piece, the leakage current from the oxide film will increase. If burrs are present on the cut surface of the foil piece, even if the oxide film layer is formed on the burrs, defects may be generated due to stress concentration in the oxide film layer depending on the shape of the burrs. Therefore, it is difficult to form a high-quality oxide film layer.

### Electrophoretic Electrodeposition Treatment after Repair Chemical Conversion (Comparative Example 1 or 4)

In the preceding repair chemical conversion treatment, an oxide film layer is formed on the base metal portion exposed at the cut surface of the foil piece. Here, as described above, the oxide film layer formed on the base metal portion exposed on the cut surface of the foil piece is made from an insulating material. Therefore, the base metal portion on which the oxide film layer is formed has high insulation provided by the oxide film layer, making it difficult for a current to flow through. Therefore, even if electrophoretic electrodeposition is attempted after the repair chemical conversion treatment, electrophoresis of the resin is hindered and the resin does not adhere to the base metal portion.

### Effects of Examples

According to the Examples of the present disclosure, any one of the following effects can be obtained.

(1) At least the base metal portion 22 exposed on the cut surface of the foil of the foil piece can be repaired with the resin layer, which is an insulating film layer, and the decrease in the withstand voltage of the oxide film layer dependent on this base metal portion 22 can be prevented. Therefore, an electrode foil with a high withstand voltage can be manufactured.

(2) The cut surface of the foil is repaired during a manufacturing stage of the foil piece, thereby increasing the withstand voltage of the energy storage device. Even when an electrode foil having an oxide film layer with a defective portion is used, the defective portion on the oxide film layer is subjected to the repair treatment after the energy storage element 2 is formed, and therefore, the withstand voltage of the energy storage device can similarly be increased.

(3) A film layer having a withstand voltage equal to or greater than that of the oxide film layer is formed on at least the defective portion of the oxide film layer that is generated on the foil piece during manufacturing, thereby increasing the withstand voltage of the entire electrode foil, so that a withstand voltage of an element using this electrode foil can be increased.

(4) The electrode foil in which the defective portion is repaired during manufacturing of the electrode foil is used, so that the withstand voltage can be increased.

### Other Embodiments

(1) Regarding the conductive polymer treatment mentioned above, poly(3,4-ethylene dioxythiophene) (PEDOT) doped with polystyrene sulfonic acid (PSS) is particularly preferred. The solid electrolyte is formed by immersing the capacitor element in a dispersion in which the solid electrolyte is dispersed in a solvent, followed by drying. The anode foil, the cathode foil and the separator may be immersed separately in the dispersion before assembly, or the dispersion may be applied thereto by drop coating or spray coating.

(2) Regarding the impregnation treatment on the energy storage element with an electrolytic solution, the energy storage element formed with a solid electrolyte layer may be impregnated with the electrolytic solution.

(3) The oxide film layer after the electrophoretic electrodeposition treatment is repaired in the foil piece state, but the repair chemical conversion may be performed in the element state before the formation treatment of the solid electrolyte layer in the element formation step. In this way, the oxide film layer damaged during the element formation step can also be repaired at the same time.

As described above, the most preferred embodiment of the present disclosure has been described. The technique of the present disclosure is not limited to the above description. Based on the gist of the invention as set forth in the claims or disclosed in the specification, those skilled in the art may perform various modifications and variations. It goes without saying that such modifications and variations are included within the scope of the present disclosure.

### INDUSTRIAL APPLICABILITY

According to the electrode foil, the energy storage device, and the manufacturing method therefor of the present disclosure, the base metal portion exposed on the cut surface of the foil is covered with an insulating film layer, thereby increasing the withstand voltage of the electrode foil, the energy storage element, or the energy storage device, and contributing to improved reliability of the energy storage device, which is useful.

### DESCRIPTIONS OF REFERENCE SIGNS

2 energy storage element
4 anode foil
6 cathode foil
8 separator
10, 12 support plate
14 anode lead portion
16 cathode lead portion
18 clip
20 cut surface
22 base metal portion
24 etching layer
26 oxide film layer
28 electrophoretic electrodeposited film

1. A manufacturing method for an electrode foil, comprising:
performing a surface expansion treatment on a foil made from a valve metal;
forming an oxide film layer on the foil subjected to the surface expansion treatment;
cutting the foil on which the oxide film layer is formed; and
forming, on a cut surface of the foil, a resin layer having a withstand voltage equal to or greater than a withstand voltage of the oxide film layer.

2. The manufacturing method for an electrode foil according to claim 1, wherein
the forming of the resin layer comprises a forming process by electrophoretic electrodeposition.

3. The manufacturing method for an electrode foil according to claim 1, comprising:
forming an oxide film by a repair chemical conversion treatment after formation of an electrophoretic electrodeposited film.

4. A manufacturing method for an energy storage device, comprising:
manufacturing an electrode foil by the manufacturing method according to claim 1;
forming an energy storage element using the electrode foil; and
forming a conductive polymer layer on the energy storage element.

5. The manufacturing method for an energy storage device according to claim 4, comprising:
performing repair chemical conversion on the energy storage element to form an oxide film on the foil.

6. An electrode foil comprising:
a foil made from a valve metal;
a surface-expanded layer formed on the foil;
an oxide film layer formed on the surface-expanded layer; and
a resin layer formed on at least a cut surface of the foil, wherein
the resin layer is formed to be thick in a base metal portion exposed on the cut surface and gradually become thinner toward a foil surface.

7. An energy storage device comprising
an energy storage element comprising the electrode foil according to claim 6, wherein
the energy storage element has a conductive polymer layer.

8. The manufacturing method for an electrode foil according to claim 2, comprising:
forming an oxide film by a repair chemical conversion treatment after formation of an electrophoretic electrodeposited film.

9. A manufacturing method for an energy storage device, comprising:
manufacturing an electrode foil by the manufacturing method according to claim 2;
forming an energy storage element using the electrode foil; and
forming a conductive polymer layer on the energy storage element.

10. The manufacturing method for an energy storage device according to claim 9, comprising:
performing repair chemical conversion on the energy storage element to form an oxide film on the foil.
